(19) United States
(12) Patent Application Publication
(10) Pub. No.: US 2006/0084045 A1
(43) Pub. Date: Apr. 20, 2006

(54) Mobile sculpture for displaying academic awards

(76) Inventor: John Banman, South El Monte, CA (US)

Correspondence Address: JAMES E. BRUNTON, ESQ., P. O. BOX 29000, GLENDALE, CA, 91209, US

(21) Appl. No.: 10/968,085

(22) Filed: Oct. 18, 2004

(51) Int. Cl. G09B 19/00

(52) U.S. Cl. 434/236

(57) ABSTRACT

An academic award mobile kit that can be used by parents of elementary school students for rewarding academic achievement, performance and effort. The kit contains a plurality of unique, cooperating components which, when easily assembled, create an attractive hanging mobile that will accommodate a plurality of award commemoratives in the form of award stickers of various designs. From time to time one of the award stickers can be selected by the parent and given to the student to reward a particular achievement by the student. The selected award sticker can then be easily applied by the student to one of the specially designed holders that form a part of the mobile sculpture so that the award can be prominently displayed in a unique and attractive manner.

### BACKGROUND OF THE INVENTION

1. Field of the Invention

This invention relates generally to mobile sculptures. More particularly, the invention concerns a mobile sculpture which forms the principal component of an award kit that can be used by parents of an elementary school student to award the student for academic performance, effort and attitude. In addition to the mobile sculpture, the award kit of the invention includes a plurality of awards provided in the form of award stickers that can be selectively applied to specially designed holders that comprise a part of the mobile sculpture.

2. Description of the Prior Art

In the past, a variety of abstract sculptures, generally termed mobiles, have been constructed to provide pleasing kinetic movement in various types of objects. This kinetic movement is generally accomplished by the interconnection of different various forms of rings, rods, discs and like decorative components that are suspended from the ceiling of a room by thread, filaments or fine wires so that the decorative components can be set in motion by air currents.

As a general rule, the prior art mobile sculptures have been constructed and used primarily for purposes of decoration. However, applicant is unaware of any prior art use of mobile sculptures as a part of an award program for awarding academic and related achievement. In this regard, one of the aims of the present invention is to devise a novel award program that features a unique mobile sculpture award kit which is of a character that can readily be marketed through elementary schools by means of open houses, or marketing flyers given to the student or mailed to the parent or by other common types of fund raising activities. Profits from sales of the kits, over and above the sales price of the kit, would be realized by the school.

Since the award kit of the invention includes the sticker awards which are to be given to the child, the parents are empowered to determine how and when their children will be rewarded via these novel sticker awards. Parents will also have the opportunity to create their own individualized student's award system based on effort, improvement or results. The sticker awards contained in the kit generally cover areas of achievement that typically occur in most elementary schools.

### BRIEF SUMMARY OF THE INVENTION

By way of brief summary, the present invention concerns a kit for construction of an academic award mobile sculpture which comprise: a first support member; a second support member interconnected with the first support member and extending substantially perpendicularly with respect thereto; a third support member interconnected with the first support member and extending substantially perpendicularly with respect thereto; first and second spaced apart award holders connected to and depending from the second support member; third and fourth spaced apart award holders connected to and depending from the third support member; and a plurality of academic award stickers selectively interconnectable with the first, second, third and fourth support members.

It is an object of the present invention to provide a novel mobile kit that can be used by parents of elementary school students for rewarding academic achievement, performance and effort.

More particularly, it is an object of the invention to provide a mobile kit of the aforementioned character that contains a plurality of unique, cooperating components which, when easily assembled, create an attractive hanging mobile that will accommodate a plurality of award commemoratives in the form of award stickers of various designs. From time to time some of the award stickers can be selected by the parent and given to the student to reward a particular achievement by the student. The selected award sticker can then be easily applied by the student in one of the specially designed holders that form a part of the mobile sculptures so that the award can be prominently displayed in a unique and attractive manner.

Another object of the invention is to provide a mobile kit of the character described that includes a plurality of stickers in the form of a school's logo, mascot or like indicia.

Another object of the invention is to provide a mobile kit that comprises blank stickers upon which the indicia can be imprinted and can be used by the parent to create individualized student award stickers that can be used to reward student effort, improvement, results and the like.

### BRIEF DESCRIPTION OF HE DRAWINGS

FIG. 1 is a generally perspective view of one form of the mobile sculpture award kit of the present invention.

FIG. 2 is a generally perspective view of the mobile sculpture component of the kit shown in FIG. 1.

FIG. 2A is an enlarged, generally perspective, exploded view of the area designated as “2A” in FIG. 2.

FIG. 3 is a greatly enlarged, cross-sectional view taken along lines 3-3 of FIG. 2.

FIG. 4 is an enlarged front view of the mobile sculpture component of the kit shown in FIG. 1.

### DESCRIPTION OF THE INVENTION

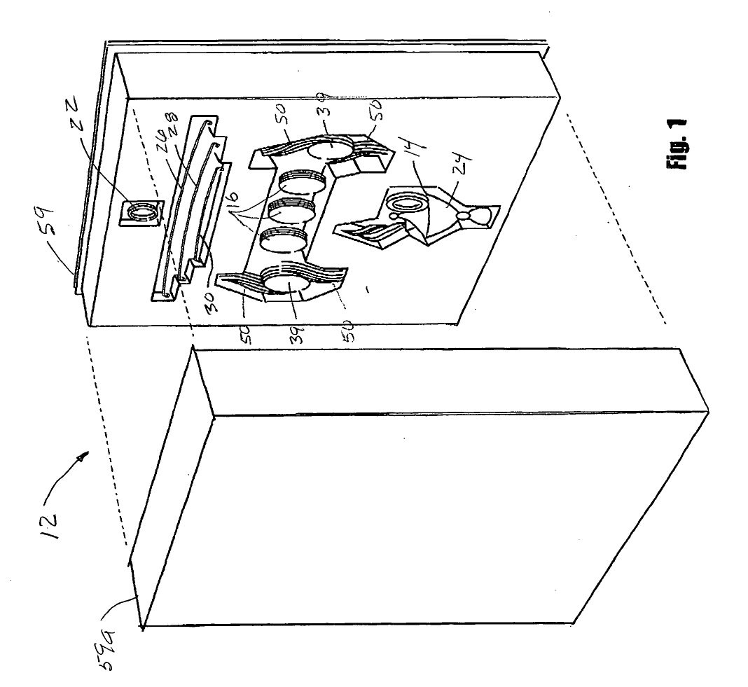

Referring to the drawings and particularly to FIGS. 1, 2 and 3, one form of the kit for construction of an academic award mobile sculpture is there shown and generally designated by the numeral 12. In the present form of the invention the kit comprises a mobile sculpture component 14 and a plurality of academic award stickers 16 that are selectively interconnectable with uniquely configured sticker support members, the character of which will presently be described.

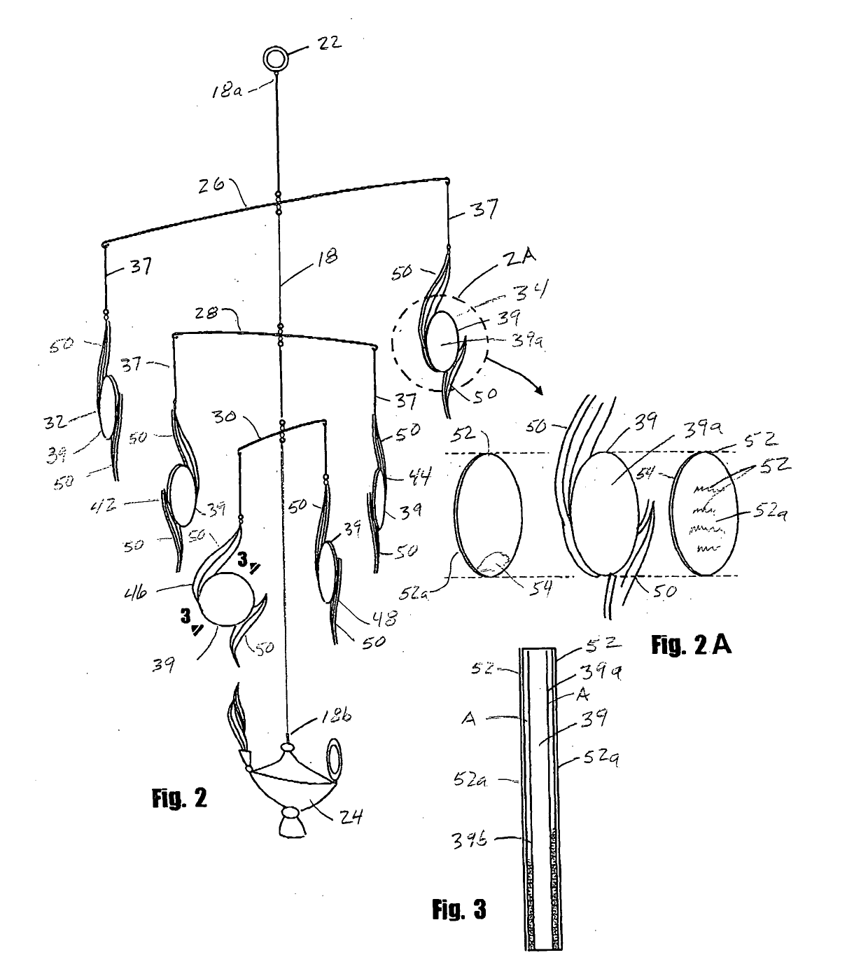

Considering first the academic award mobile sculpture, as best seen in FIG. 2, this important component includes a first support member comprising an elongated filament or support strand 18 having a first end 18a and a second end 18b. Connected to first end 18a of the filament is a connector means for interconnecting the mobile with a structural member such as a room ceiling, beam, structural arch, or the like. In the present embodiment of the invention, this connector means comprises a generally ring-shaped member 22 that can be connected to a hook or other connector (not shown) that is, in turn, connected to the structural member that supports the mobile. Affixed to the second end 18b of the filament is a generally lamp-shaped decorative weight 24 which functions to keep filament 18 taught when the mobile is hanging from the structural member.

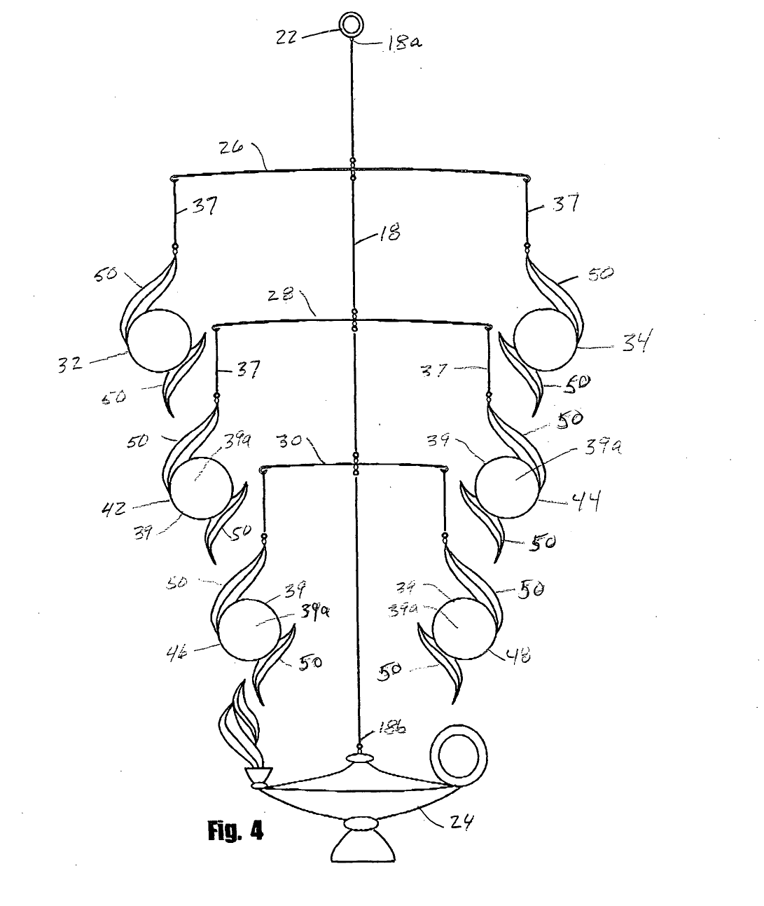

As illustrated in FIGS. 2 and 4, a second support member 26 is interconnected with first support member, or strand 18 and extends substantially perpendicularly with respect thereto. Similarly, third and fourth support members 28 and 30 are interconnected with first support member 16 and also extend substantially perpendicularly with respect thereto. Second, third and fourth support members are preferably constructed from a semirigid material such as a metal wire or plastic. Provided at each end of the second, third and fourth support members is a hook-like extremity, the purpose of which will presently be described.

First and second spaced apart award holder assemblies 32 and 34 are connected to second support member by elongated, very thin filaments 37 the ends of which are connected to the hook-like extremities provided proximate the ends of the second support member. With this construction, award holder assemblies 32 and 34 depend from the ends of the second support member and are free to rotate and sway in air currents as though suspended in space. As indicated in FIG. 3, each of the first and second spaced apart award holder assemblies include a generally circular-shaped body portion 39 having generally planar first and second opposing surfaces 39a and 39b (see also FIG. 2A).

In a similar manner, third and fourth spaced apart award holder assemblies 42 and 44 are connected to third support member 28 by elongated, very thin filaments 37 the ends of which are connected to the hook-like extremities provided proximate the ends of the third support member. Third and fourth award holder assemblies 42 and 44 are of identical construction to award holder assemblies 32 and 34 and each includes a generally circular-shaped body portion 39 having generally planar first and second opposing surfaces 39a and 39b. As before, award holder assemblies 42 and 44 are free to rotate and sway relative to third support member 28 and, accordingly, appear to be suspended in space.

In like manner, fifth and sixth spaced apart award holder assemblies 46 and 48 are connected to fourth support member 30 by elongated, very thin filaments 37 the ends of which are connected to the hook-like extremities provided proximate the ends of the fourth support member. Fifth and sixth award holder assemblies 46 and 48 are also of identical construction to award holder assemblies 32 and 34 and each includes a generally circular-shaped body portion 39 having generally planar first and second opposing surfaces 39a and 39b. As before, award holder assemblies 46 and 48 are free to rotate and sway relative to fourth support member 30 and, accordingly, also appear to be suspended in space.

As illustrated in FIG. 4, each of the award holder assemblies include a pair of oppositely disposed, gracefully curved, leaf-like decorative members or segments 50 that are affixed to the periphery of the circular-shaped body portion of the award holder. It is to be understood that the award holder assemblies of the apparatus of the invention can be of various configurations and designs so long as they comprise an attractive presentation and provide surfaces to which the previously identified academic award stickers 16 can be affixed.

As indicated in FIGS. 2A and 3 of the drawings, the academic award stickers, which can be selectively interconnected with the first, second, third, fourth, fifth and sixth support members, each include a generally circular-shaped body member 52 each having a first face 52a that is provided with indicia 53 (FIG. 2A) which represents an award that can be given to the student. As previously mentioned, indicia 53 can comprise words defining an achievement, designs, such as the schools mascot or logo, or any other suitable award depiction. Each of the award stickers also includes a second, opposing face 52b which is adapted to carry a thin layer of a suitable adhesive “A” of a character well known to those skilled in the art. Prior to being affixed to the award holders, the adhesive portion of the award stickers is protected by peel strips 54 (FIG. 2A) which are of a conventional construction and which can be readily peeled away from the adhesive carrying surface of the sticker.

As indicated in FIG. 1, prior to assembly of the academic award mobile sculpture, the components parts thereof are conveniently stored within a container 59 having a removable cover 59a.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A kit for construction of an academic award mobile sculpture comprising:
(a) a first support member;
(b) a second support member interconnected with said first support member and extending substantially perpendicularly with respect thereto;
(c) third support member interconnected with said first support member and extending substantially perpendicularly with respect thereto;
(d) first and second spaced apart award holders connected to and depending from said second support member;
(e) a third and fourth spaced apart award holders connected to and depending from said third support member; and
(f) a plurality of academic award stickers selectively interconnectable with said first, second, third and fourth support members.

2. The kit as defined in claim 1 in which said first support member comprises a filament.

3. The kit as defined in claim 1 in which said first, second, third and fourth award holders comprise substantially planar members each having oppositely disposed, generally smooth planar surfaces.

4. The kit as defined in claim 1 in which each of said plurality of academic award stickers comprises:
(a) a generally planar member having oppositely disposed first and second surfaces;
(b) a layer of adhesive affixed to said first surface of said generally planar member; and
(c) a peel strip removably affixed to said layer of adhesive.

5. The kit as defined in claim 1 further including connector means connected to said first end of said first support member for interconnecting said first support member with a structural member.

6. The kit as defined in claim 1 further including a weight connected to said second end of said first support member.

7. The kit as defined in claim 1 in which each of said first, second, third and fourth award holders further includes a curved decorative member connected to said substantially planar member.

8. The kit as defined in claim 1 further including a fourth support member interconnected with said first support member and extending substantially perpendicularly with respect thereto.

9. The kit as defined in claim 8 further including fifth and sixth spaced apart award holders interconnected with said fourth support member.

10. A kit for construction of an academic award mobile sculpture comprising:
(a) a first support member comprising an elongated filament having a first end and a second end;
(b) a second support member interconnected with said first support member and extending substantially perpendicularly with respect thereto;
(c) a third support member interconnected with said first support member and extending substantially perpendicularly with respect thereto;
(d) a fourth support member interconnected with said first support member and extending substantially perpendicularly with respect thereto;
(e) first and second spaced apart award holders connected to and depending from said second support member, each of said first and second spaced apart award holders comprising a generally circular-shaped body portion;
(f) third and fourth spaced apart award holders connected to and depending from said third support member, each of said third and fourth spaced apart award holders comprising a generally circular-shaped body portion;
(g) fifth and sixth spaced apart award holders connected to and depending from said fourth support member, each of said fifth and sixth spaced apart award holders comprising a generally circular-shaped body portion;
(h) a plurality of academic award stickers selectively interconnectable with said first, second, third, fourth, fifth and sixth support members, each of said award stickers of said plurality of award stickers comprising a generally circular-shaped member having a first face provided with indicia and a second opposing face; and an adhesive layer carried by said second face;
(i) connector means connected to said first end of said first support member for interconnecting said first support member with a structural member; and
(j) a weight connected to said second end of said first support member.

11. The kit as defined in claim 10 in which each of said first, second, third, fourth, fifth and sixth award holders further includes a curved decorative member connected to said generally circular-shaped body portion.

12. The kit as defined in claim 10, in which said weight comprises a generally lamp-shaped member.

13. The kit as defined in claim 10 further including a peel strip connected to said adhesive layer of each of said plurality of academic award stickers.

14. The kit as defined in claim 10 in which said first and second spaced apart award holders are connected to said second support member by an elongated filament.

15. The kit as defined in claim 10 in which said third and fourth spaced apart award holders are connected to said third support member by an elongated filament.

16. The kit as defined in claim 10 in which said fifth and sixth spaced apart award holders are connected to said third support member by an elongated filament.

17. A kit for construction of an academic award mobile sculpture comprising:
(a) a first support member comprising an elongated filament having a first end and a second end;
(b) a second support member interconnected with said first support member and extending substantially perpendicularly with respect thereto;
(c) a third support member interconnected with said first support member and extending substantially perpendicularly with respect thereto;
(d) a fourth support member interconnected with said first support member and extending substantially perpendicularly with respect thereto;
(e) first and second spaced apart award holders connected to said second support member by an elongated filament, each of said first and second spaced apart award holders comprising a generally circular-shaped body portion having generally planar first and second opposing surfaces;
(f) third and fourth spaced apart award holders connected to said third support member by an elongated filament, each of said third and fourth spaced apart award holders comprising a generally circular-shaped body portion having generally planar first and second opposing surfaces;
(e) fifth and sixth spaced apart award holders connected to said fourth support member by an elongated filament, each of said fifth and sixth spaced apart award holders comprising a generally circular-shaped body portion having generally planar first and second opposing surfaces;
(f) a plurality of academic award stickers selectively interconnectable with said first, second, third, fourth, fifth and sixth support members, each of said award stickers of said plurality of award stickers comprising a generally circular-shaped member having a first face provided with indicia and second opposing face; an adhesive layer carried by said second face; and a peel strip removably connected to said adhesive layer;
(g) connector means comprising a generally ring-shaped member connected to said first end of said first support member for interconnecting said first support member with a structural member; and
(h) a generally lamp-shaped weight connected to said second end of said first support member.

18. The kit as defined in claim 10 in which each of said first, second, third, fourth, fifth and sixth award holders further includes a first curved member connected to said generally circular-shaped body portion.

19. The kit as defined in claim 18, in which each of said first, second, third, fourth, fifth and sixth award holders further includes a second curved member connected to said generally circular-shaped body portion.

20. The kit as defined in claim 10 in which an academic award sticker is interconnected with each of said generally planar first and second opposing surfaces of each of said first, second, third, fourth, fifth and sixth award holders.
